(19) United States
(12) Patent Application Publication
(10) Pub. No.: US 2007/0025652 A1
(43) Pub. Date: Feb. 1, 2007

(54) Fluid bearing device

(75) Inventors: Fuminori Satoji, Mie-ken (JP); Kenji Itou, Mie-ken (JP); Katsuo Shibahara, Mie-ken (JP)

Correspondence Address: ARENT FOX PLLC, 1050 CONNECTICUT AVENUE, N.W., SUITE 400, WASHINGTON, DC, 20036, US

(73) Assignee: NTN CORPORATION, Osaka-Shi, Osaka-Fu (JP)

(21) Appl. No.: 10/548,170

(22) PCT Filed: Mar. 30, 2004
(86) PCT No.: PCT/JP04/04560

§ 371 Date: Jun. 6, 2006

(30) Foreign Application Priority Data
Mar. 31, 2003 (JP) 2003-094826
Jul. 23, 2003 (JP) 2003-278428

(51) Int. Cl. F16C 32/06

(52) U.S. Cl. 384/100

(57) ABSTRACT

A fluid bearing device which enables cost reductions and prevents static electricity charging. A bearing sleeve is secured inside a housing, and a shaft member is inserted inside an inner peripheral surface of the bearing sleeve. A lubricating oil dynamic pressure effect is used to generate pressure within a bearing gap between the inner peripheral surface of the bearing sleeve and an outer peripheral surface of the shaft member, thereby supporting the shaft member in a non-contact manner in the radial direction. An axial end portion of the shaft member contacts a housing bottom portion, enabling conductivity between the two members, and the housing is made of a conductive resin composition containing added carbon nanofiber with a volume resistivity of 10⁶ Ω·cm or less.

### BACKGROUND OF THE INVENTION

The present invention relates to a fluid bearing device which supports a rotating member in a non-contact manner via a lubricating oil film that is generated within a radial bearing gap and a dynamic bearing device (a fluid dynamic bearing device) which supports a rotating member in a non-contact manner via a lubricating oil dynamic pressure effect that is generated within a bearing gap. These bearing device is ideal for use in information-processing equipment, including the spindle motors for magnetic disk devices such as HDD and FDD, optical disk devices for CD-ROM, CD-R/RW, DVD-ROM/RAM, etc. and magneto-optical disk devices for MD, MO, etc., the polygon scanner motors in laser beam printers (LBP), or as small-scale motors for electrical equipment such as axial flow fans.

In each of the motor types described above, in addition to high rotational precision, other sought after performance factors include increased speed, lower costs, and lower noise generation. One of the structural elements that determines the performance of the motor in terms of these factors is the bearing that supports the spindle of the motor. In recent years, fluid bearing devices, which display superior results for the above performance factors, have been investigated, and in some cases used in actual applications.

These fluid bearing devices can be broadly classified into so-called dynamic bearings, which are equipped with dynamic-pressure generating means for generating a dynamic pressure in the lubricating oil within the bearing gap, and so-called cylindrical bearings (bearings in which the bearing surface is a complete round shape) which contain no dynamic-pressure generating means.

For example, amongst fluid bearing devices incorporated within the spindle motor of a disk device for HDD or the like, or within the polygon scanner motor of a LBP, a construction in which a bearing sleeve is secured to the inner periphery of the housing, and a shaft member is positioned inside this bearing sleeve is already known (Japanese Patent Laid-Open Publication No. 2002-061636). In this bearing device, rotation of the shaft member causes pressure to be generated by a fluid dynamic pressure effect in the radial bearing gap between the inner periphery of the bearing sleeve and the outer periphery of the shaft member, and the shaft member is supported in a non-contact manner in the radial direction through the action of this pressure.

Conventionally, the housings of the fluid bearing devices described above have used turned housings machined from a metal such as brass or copper. However, turned metal products are expensive to produce, and present a barrier to attempts to lower the costs of the bearing device.

Moreover, in a fluid bearing device of the construction described above, because the shaft member and the housing are insulated from each other during rotation by the lubricating oil, the static electricity generated by friction between the rotating body, such as the magnetic disk, and the surrounding air is unable to dissipate, and can easily cause charging of the rotating body. If this charge is ignored, then there is a danger that it may cause a variety of problems, including the development of a potential difference between the magnetic disk and the magnetic head, or the damage of surrounding equipment through discharge of the static electricity.

It is noted, for example, a dynamic bearing device incorporated within the spindle motor of a disk drive device for HDD or the like is provided with a radial bearing portion, which supports the shaft member in a non-contact manner in the radial direction, and a thrust bearing portion, which supports the shaft member in a non-contact manner in the thrust direction. The radial bearing portion utilizes a dynamic bearing in which grooves for generating the dynamic pressure (dynamic-pressure generating grooves) are provided in either the inner peripheral surface of the bearing sleeve or the outer peripheral surface of the shaft member. The thrust bearing portion utilizes a dynamic bearing in which, for example, dynamic-pressure generating grooves are provided in either both end surfaces of a flange portion of the shaft member or in the surfaces opposing these end surfaces (such as the end surface of the bearing sleeve, or the end surface of a thrust member that is fixed to the housing). Alternatively, bearings in which one end surface of the shaft member is supported through contact with a thrust plate (so-called pivot bearings) may also be used as the thrust bearing portion.

Normally, the bearing sleeve is fixed to a predetermined position on the inner periphery of the housing, and a seal member is often disposed within the open portion of the housing to prevent external leakage of the lubricating oil used to fill the internal space within the housing. Alternatively, the seal portion may also be formed as an integrated part at the open portion of the housing.

In addition, in order to prevent leakage of the lubricating oil, an oil repellent may also be applied to the outer peripheral surface of the shaft member, the outside surface of the housing that connects through to the radial bearing gap, and the inner peripheral surface of the seal member.

This type of dynamic bearing device comprises components including a housing, a bearing sleeve, a shaft member, a thrust member, and a seal member, and in order to ensure the high level of bearing performance required to keep pace with the rapidly improving performance of information-processing equipment, strenuous efforts are being made to improve the processing precision and assembly precision of each of these components. On the other hand, with the trend towards lower cost information-processing equipment, the demand for cost reductions of these types of dynamic bearing devices is also growing stronger.

Accordingly, an object of the present invention is to provide a fluid bearing device capable of achieving cost reductions and reliably preventing charging caused by static electricity.

Furthermore, an object of the present invention is to provide a dynamic bearing device which provides a reduction in the manufacturing costs of the housing used in this type of dynamic bearing device, and also enables a reduction in the number of components, and simplified processing step and assembly step, thereby offering even lower costs.

### SUMMARY OF THE INVENTION

In order to resolve the problems described above, a fluid bearing device according to the present invention comprises a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member, wherein the fluid bearing device further comprises conducting means which enables conduction between the shaft member and the housing, and the housing is made of a conductive resin.

By producing the housing from a resin in this manner, the housing can be formed with high precision and at low cost using a molding process such as injection molding. Particularly if the housing is formed by resin molding (insert molding) with the bearing sleeve as an insert component, the operation of assembling the housing and the bearing sleeve becomes unnecessary, enabling further reductions in the cost of assembly.

However, because resins are normally insulating materials, a resin housing such as that described above would be unable to discharge accumulated static electricity through the housing and to ground, meaning charging caused by static electricity becomes a problem. As a solution to this problem, if conducting means which enables conduction between the shaft member and the housing is provided between these two members, and the housing is made of a resin that displays conductivity (a conductive resin composition), then static electricity that has accumulated on the disk or the like during relative rotation of the shaft member and the bearing sleeve can pass through the shaft member, the conducting means and then the housing, and be discharged at a grounded member (such as a casing 6), thereby enabling charging caused by static electricity to be reliably prevented.

In such cases, the housing is preferably made of a conductive resin composition with a volume resistivity of 10⁶ Ω·cm or lower. If the volume resistivity exceeds 10⁶ Ω·cm, then the conductivity of the housing becomes inadequate, and even if the conducting means enables conductivity to be achieved between the shaft member and the housing, the static electricity can still not be reliably discharged to ground.

A specific example of the conducting means involves the use of a conductive lubricating oil. This lubricating oil is used to fill the bearing gap, and consequently static electricity can be discharged to ground through a route which passes from the shaft member, through the lubricating oil, the bearing sleeve (which is normally made of a conductive sintered alloy or soft metal), and then the housing. In addition to this route, the static electricity may also be discharged from the shaft member, through the lubricating oil and then the housing, without passing through the bearing sleeve.

Furthermore, a thrust bearing portion which supports the shaft member in a contact manner in a thrust direction can also be used as the conducting means. In this case, static electricity is mainly discharged to ground through a route which passes from the shaft member, through the thrust bearing portion, and then the housing. Furthermore, a conductive lubricating oil could also be used in combination with this thrust bearing portion, and in this case, static electricity could also be discharged through a route which passes from the shaft member, and then through the lubricating oil to the housing.

Mixing a metal powder or carbon fiber into the resin matrix as a conducting agent could also be considered as means for ensuring conductivity of the housing. However, these types of conducting agents typically display large particle sizes, with particle diameters or fiber diameters of several dozen μm to several hundred μm, and a large quantity must be added to ensure adequate conductivity. As a result, the fluidity of the resin deteriorates, the dimensional precision of the molded product worsens, and when the housing slides relative to other members (for example, when the bearing sleeve is press fitted inside the inner peripheral surface of the housing, or when the housing is assembled with the motor), there is a danger that these conducting agents will separate from the resin matrix, causing contamination.

In contrast, if the housing is made of a conductive resin composition containing either 8% by weight or less of a finely powdered conducting agent with an average particle size of 1 μm or smaller, or 20% by weight or less of a fibrous conducting agent (such as carbon fiber) with an average fiber diameter of 10 μm or smaller and an average fiber length of 500 μm or less, then because the particle size of the conducting agent is small and the quantity added is also small, good fluidity can be retained in the resin molten state, and the conducting agent is also unlikely to separate from the resin matrix, thereby avoiding any potential problems of contamination.

The use of carbon nanomaterials as the conducting agent is preferred. When compared with conventionally used conducting agents such as carbon black, graphite, carbon fiber, and metal powders, carbon nanomaterials offer the following special characteristics.

(1) A high conductivity, meaning a good level of conductivity can be achieved with small addition quantities.

(2) A high aspect ratio, enabling ready dispersion within a matrix. Furthermore, also resistant to abrasive friction with minimal separation due to friction.

(3) Require only small addition quantities, and consequently do not impair the physical properties of the resin, meaning the fluidity of the resin in the molten state remains favorable.

(4) Contain minimal impurities, and generate less out-gas than conventional conducting agents (particularly carbon based agents).

Accordingly, if the housing is formed using a conductive resin composition containing a carbon nanomaterial as the conducting agent, then static electricity that has accumulated on the disk or the like can be reliably discharged to ground, while any reductions in resin fluidity or problems of contamination can be avoided. Specifically, if the quantity of the carbon nanomaterial added to the conductive resin composition is set within a range from 1 to 10 wt %, then a volume resistivity described above (at most 10⁶ Ω·cm) can be realized.

Carbon nanofibers and fullerenes such as C60 are famous examples of carbon nanomaterials. Of these, because fullerenes are typically insulating materials, the present invention preferably employs carbon nanofiber with a good level of conductivity. In this description the term carbon nanofiber includes so-called “carbon nanotubes” with a diameter of 40 to 50 nm or less.

Specific examples of this carbon nanofiber include single-wall carbon nanotubes, multi-wall carbon nanotubes, cup-stacked type carbon nanofiber, and vapor grown carbon fiber. In the present invention, any of these carbon nanofibers can be used (and in addition to using any one of the above, a mixture of two or more different nanofibers can also be used).

These carbon nanofibers can be produced by arc discharge methods, laser deposition methods, or chemical vapor phase epitaxy methods.

During operation of the bearing, the temperature of the housing rises due to generated heat, and if the resulting degree of expansion is large, then there is a danger of a deformation of the bearing sleeve, and a deterioration in the precision of the dynamic-pressure generating grooves. In order to prevent this situation arising, the housing is preferably formed using a resin composition with a coefficient of linear expansion, and particularly a coefficient of linear expansion in the radial direction, of 5×10⁻⁵/°C. or lower.

In addition to using metal, the bearing sleeve may also be made of any of the conductive resin compositions described above with a volume resistivity of 10⁶ Ω·cm or lower. This enables the conductivity of the bearing sleeve to be retained, and enables static electricity that has accumulated on the disk or the like to be reliably discharged to ground via the conductive housing.

As described above, the present invention enables a reduction in the cost of bearing devices. Furthermore, because the present invention also enables the reliable prevention of charging caused by static electricity, the operating stability of information-processing equipment containing this bearing device can be improved.

Furthermore, the present invention provides a dynamic bearing device comprising a housing, a bearing sleeve secured inside the housing, a rotating member which undergoes relative rotation with respect to the housing and the bearing sleeve, a radial bearing portion which supports the rotating member in a non-contact manner in a radial direction via a lubricating oil dynamic pressure effect that is generated within a radial bearing gap between the bearing sleeve and the rotating member, and a thrust bearing portion which supports the rotating member in a non-contact manner in a thrust direction via a lubricating oil dynamic pressure effect that is generated within a thrust bearing gap between the housing and the rotating member, wherein the housing is formed by molding a resin material, and comprises a thrust bearing surface which constitutes the thrust bearing portion and dynamic-pressure generating grooves which are formed in the thrust bearing surface during molding of the housing.

A housing produced by molding (such as injection molding) of a resin material can not only be manufactured at lower cost than a metal housing produced by machining techniques such as turning, but also provides a comparatively higher level of precision when compared with a metal housing produced by press working.

Furthermore, by providing a thrust bearing surface in the housing itself, the need to provide a separate member with a thrust bearing surface is removed, which reduces both the number of components and the labor required for assembly. In addition, by forming the dynamic-pressure generating grooves in the thrust bearing surface of the housing during the molding of the housing (by forming a molding pattern in the molding die for molding the housing which molds the dynamic-pressure generating grooves), the need to form the dynamic-pressure generating grooves in a separate process is eliminated, which reduces the labor required in the processing step, and improves the precision of the dynamic-pressure generating grooves in terms of shape and groove depth and the like in comparison with methods in which the dynamic-pressure generating grooves are formed in metal components by machining, etching, or electrochemical machining.

The thrust bearing surface can be provided at the inner bottom surface at one end of the housing or at the end surface at the other end of the housing.

Furthermore, by providing a stepped portion in the housing, so that the end surface at one end of the bearing sleeve contacts this stepped portion of the housing, the positioning of the bearing sleeve in the axial direction relative to the housing can be performed easily. In particular, by providing this stepped portion at a predetermined distance in the axial direction from the inner bottom surface of the housing, the thrust bearing gap can be set precisely and easily.

There are no particular restrictions on the resin used to form the housing, provided a thermoplastic resin is used, and examples of suitable non-crystalline resins include polysulfones (PSF), polyethersulfones (PES), polyphenylsulfones (PPSF), and polyetherimides (PEI), whereas examples of suitable crystalline resins include liquid crystal polymers (LCP), polyetheretherketones (PEEK), polybutylene terephthalate (PBT), and polyphenylene sulfides (PPS).

Furthermore, there are also no particular restrictions on the addition of fillers to the above resin, and examples of suitable fillers include fibrous fillers such as glass fiber, whisker fillers such as potassium titanate, scaly fillers such as mica, and fibrous or powdered conductive fillers such as carbon fiber, carbon black, graphite, carbon nanomaterials, and metal powders. These fillers can be used singularly, or in mixtures of two or more different fillers.

For example, in a dynamic bearing device incorporated within a spindle motor for a disk drive device for HDD or the like, the housing may require a level of conductivity to enable static electricity generated by friction between the disk such as the magnetic disk and air to be dissipated to ground. In such cases, by adding a conductive filler described above to the resin used for forming the housing, conductivity can be imparted to the housing.

From the viewpoints of achieving a high level of conductivity, favorable dispersibility within the resin matrix, favorable abrasion resistance, and a low level of out-gas, carbon nanomaterials are preferred as the aforementioned conductive filler. Of the available carbon nanomaterials, carbon nanofiber is preferred. These carbon nanofibers include so-called “carbon nanotubes” with a diameter of 40 to 50 nm or less.

Specific examples of this carbon nanofiber include single-wall carbon nanotubes, multi-wall carbon nanotubes, cup-stacked type carbon nanofiber, and vapor grown carbon fiber, and in the present invention, any of these carbon nanofibers can be used. Furthermore, in addition to using any one of the above, a mixture of two or more different carbon nanofibers or a mixture of carbon nanofibers with another filler can also be used. When using carbon nanomaterials as the conductive filler, the mixture preferably contains from 2 to 8% by weight of the carbon nanomaterials.

Furthermore, if the conductive filler material is carbon fiber with an average fiber diameter of 10 μm or less, and particularly carbon fiber with an average fiber diameter of 10 μm or less and an average fiber length of 500 μm or less, then because the particle size of the filler material is small and the quantity added is also small, good fluidity can be retained in the resin molten state, and the filler material is also unlikely to separate from the substrate resin, thereby avoiding any potential problems of contamination. When using such carbon fiber as the conductive filler material, the mixture preferably contains between 5 and 20% by weight.

According to the present invention, a dynamic bearing device can be provided which provides a reduction in the manufacturing costs of the housing used in this type of dynamic bearing device, and also enables a reduction in the number of components, and a simplified processing step and assembly step, thereby offering even lower costs.

As being described above, one possible technique for achieving a cost reduction for the types of fluid bearing devices described above involves forming the housing by injection molding of a resin material. However, depending on the configuration of the injection molding, and particularly on the shape and position of the gate through which the molten resin is injected into the internal cavity, the required molding precision for the housing may not be achievable. Furthermore, the gate removal portion, which is formed by removal (by mechanical processing) of a resin gate portion that is produced following the injection molding process, is formed at the surface where oil repellency is required, and even if an oil repellent is applied to this surface, a satisfactory oil repellent effect may still be unattainable.

For example in a case such as that shown in FIG. 14(a), wherein a housing 7′ comprising a cylindrical side portion 7b′, and a seal portion 7a′ which forms a single, continuous integrated unit with the side portion 7b′ and extends radially inward from one end of the side portion 7b′ is formed by injection molding of a resin material, typically, as shown in FIG. 14(b), a method is employed in which a disk gate 17a′ is provided in a central portion at one end of the molding die cavity 17′, and a molten resin P is then injected into the cavity 17′ through this disk gate 17a′. However, in this molding method, the molded product produced by molding comprises a resin gate portion 7d′ that is connected to the inner peripheral edge of the outside surface 7a2′ of the seal portion 7a′, as shown in FIG. 14(c) (section A). Accordingly, following molding, a removal process (mechanical processing) is conducted to remove the resin gate portion 7d′ along either the line X or the line Y shown in FIG. 14(c). As a result, if a removal process is performed in which the resin gate portion 7d′ is removed along the line X, then a gate removal portion (a mechanically processed surface) is formed on the inner peripheral edge of the outside surface 7a2′ of the seal portion 7a′, whereas if a removal process is performed in which the resin gate portion 7d′ is removed along the line Y, then a gate removal portion (a mechanically processed surface) is formed across the entire outside surface 7a2′ of the seal portion 7a′.

Typically, the oil repellency of an oil repellent is significantly affected by the surface state of the base material to which it is applied, and the oil repellency on a mechanically processed resin surface is inferior to that observed on a molded surface. On the other hand, the area of the outside surface 7a2′ of the seal portion 7a′ that most requires oil repellency is the inner peripheral area nearest to the inner peripheral surface 7a1′ which forms the seal surface. However, in the molding method described above, a gate removal portion formed by removing the resin gate portion 7d′ is formed at the inner peripheral area of the outside surface 7a2′ regardless of whether the removal process is conducted along the line X or the line Y, and as a result, even if an oil repellent is applied to the outside surface 7a2′, a satisfactory level of oil repellency is often unattainable.

In order to resolve the above problems, the present invention provides a fluid bearing device comprising a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member, wherein the housing is formed by injection molding of a resin material, and comprises a cylindrical side portion and a seal portion which forms a single, continuous integrated unit with the side portion and extends radially inward from one end of the side portion, the seal portion comprises an inner peripheral surface which forms a sealing space with an opposing outer peripheral surface of the shaft member, and an outside surface which is positioned adjacent to the inner peripheral surface, and an outer peripheral edge of this outside surface comprises a gate removal portion formed by removing a resin gate portion.

By forming the housing by injection molding of a resin material, not only can the housing be manufactured at a lower cost than a metal housing produced by a mechanical process such as turning, but a comparatively higher level of precision can be achieved than a metal housing produced by press working. Furthermore, by forming the seal portion as an integrated section of the housing, both the number of components and the number of assembly steps can be reduced in comparison with the case where a separate seal member is secured inside the housing.

Furthermore, the housing also comprises a gate removal portion formed by removing the resin gate portion at the outer peripheral edge of the outside surface of the seal portion. In other words, with the exception of the outer peripheral edge where the gate removal portion is located, the outside surface of the seal portion is a molded surface, and by applying an oil repellent to an outside surface with this type of surface state, a satisfactory oil repellency effect can be achieved, enabling effective prevention of any leakage of the lubricating oil from inside the housing.

Depending on the shape of the gate in the molding die, the gate removal portion may appear as a single point, a plurality of points, or a ring shape, at the outer peripheral edge of the outside surface of the seal portion. However, from the viewpoints of ensuring a uniform filling of the mold cavity with molten resin, and improving the molding precision of the housing, the gate is preferably formed in a ring shape, meaning the gate removal portion also appears as a ring shape. Accordingly, the gate removal portion is preferably a ring shape.

There are no particular restrictions on the resin used to form the housing provided a thermoplastic resin is used, and examples of suitable non-crystalline resins include polysulfones (PSF), polyethersulfones (PES), polyphenylsulfones (PPSF), and polyetherimides (PEI). Furthermore, examples of suitable crystalline resins include liquid crystal polymers (LCP), polyetheretherketones (PEEK), polybutylene terephthalate (PBT), and polyphenylene sulfides (PPS).

Furthermore, there are also no particular restrictions on the addition of fillers to the above resin, and examples of suitable fillers include fibrous fillers such as glass fiber, whisker fillers such as potassium titanate, scaly fillers such as mica, and fibrous or powdered conductive fillers such as carbon fiber, carbon black, graphite, carbon nanomaterials, and metal powders.

For example, in a fluid bearing device incorporated within a spindle motor for a disk drive device for HDD or the like, the housing may require a level of conductivity, to enable static electricity generated by friction between the disk such as the magnetic disk and air to be dissipated to ground. In such cases, by adding a conductive filler described above to the resin used for forming the housing, conductivity can be imparted to the housing.

From the viewpoints of achieving a high level of conductivity, favorable dispersibility within the resin matrix, favorable abrasion resistance, and a low level of out-gas, carbon nanomaterials are preferred as the aforementioned conductive filler. Of the available carbon nanomaterials, carbon nanofiber is preferred. These carbon nanofibers include so-called “carbon nanotubes” with a diameter of 40 to 50 nm or less.

Furthermore in order to resolve the above problems the present invention also provides a method of manufacturing a fluid bearing device comprising a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member, Here, the method comprises a housing molding step of molding the housing by injection molding of a resin material, the housing comprising a cylindrical side portion, and a seal portion which forms a single, continuous integrated unit with the side portion and extends radially inward from one end of the side portion, wherein the seal portion comprises an inner peripheral surface which forms a sealing space with an opposing outer peripheral surface of the shaft member, and an outside surface which is positioned adjacent to the inner peripheral surface, and in the housing molding step, a ring shaped film gate is provided in a position corresponding with an outer peripheral edge of the outside surface of the seal portion, and a molten resin is injected through this film gate into a cavity used for molding the housing.

In the housing molding step, by providing a ring shaped film gate in a position corresponding with the outer peripheral edge of the outside surface of the seal portion, and injecting a molten resin through this film gate into the cavity used for molding the housing, the molten resin fills the cavity uniformly in both a circumferential direction and an axial direction, enabling the production of a housing with a high degree of dimensional precision.

In this description, the film gate refers to a gate with a narrow gate width, and although the gate width varies depending on factors such as the physical properties of the resin material and the injection molding conditions, it is typically from 0.2 mm to 0.8 mm. Because this type of film gate is provided in a position corresponding with the outer peripheral edge of the outside surface of the seal portion, the molded product following molding is shaped such that a film-like (thin) resin gate portion is connected in a ring shaped manner to the outer peripheral edge of the outside surface of the seal portion. In many cases this film-like resin gate portion fragments automatically during the operation of opening the molding die, so that when the molded product is removed from the molding die, a fragmented section of the resin gate portion remains at the outer peripheral edge of the outside surface of the seal portion. The gate removal portion formed by removing this type of residual resin gate portion appears as a narrow ring shape at the outer peripheral edge of the outside surface of the seal portion.

According to the present invention, a fluid bearing device can be provided which enables a reduction in the manufacturing costs of the housing, and also enables a more efficient assembly process, thereby offering even lower costs. Furthermore, according to the present invention, the molding precision of a housing produced by resin injection molding can be improved. In addition, according to the present invention, the problem of a reduction in oil repellency at the gate removal portion of a housing produced by resin injection molding can be resolved.

### BRIEF DESCRIPTION OF THE DRAWINGS

FIG. 1 is a cross-sectional view showing one embodiment of a fluid bearing device according to the present invention.

FIG. 2 is a cross-sectional view showing another embodiment of a fluid bearing device according to the present invention.

FIG. 3 is a cross-sectional view showing a spindle motor with the aforementioned fluid bearing device incorporated therein.

FIG. 4 is a cross-sectional view showing a spindle motor for information-processing equipment which incorporates a dynamic bearing device according to an embodiment of the present invention;

FIG. 5 is a cross-sectional view showing a dynamic bearing device according to an embodiment of the present invention;

FIG. 6 is a drawing showing the housing viewed from the direction A in FIG. 5;

FIG. 7a is a drawing showing a cross-sectional view of a bearing sleeve, FIG. 7b is a drawing showing a lower end surface view of the bearing sleeve, and FIG. 7c is a drawing showing an upper end surface view of the bearing sleeve;

FIG. 8 is a cross-sectional view showing a spindle motor for information-processing equipment which incorporates a dynamic bearing device according to another embodiment of the present invention;

FIG. 9 is a cross-sectional view showing a dynamic bearing device according to another embodiment of the present invention; and

FIG. 10 is a drawing showing the housing viewed from the direction B in FIG. 9.

FIG. 11 is a cross-sectional view of a spindle motor for information-processing equipment, using a fluid bearing device according to the present invention;

FIG. 12 is a cross-sectional view showing an embodiment of a fluid bearing device according to the present invention;

FIGS. 13a and 13b are a cross-sectional view showing a schematic illustration of a molding step for a housing; and

FIGS. 14a, 14b and 14c are a cross-sectional view showing a schematic illustration of a molding step for a conventional housing.

### DETAILED DESCRIPTION OF THE PREFERRED EMBODIMENTS

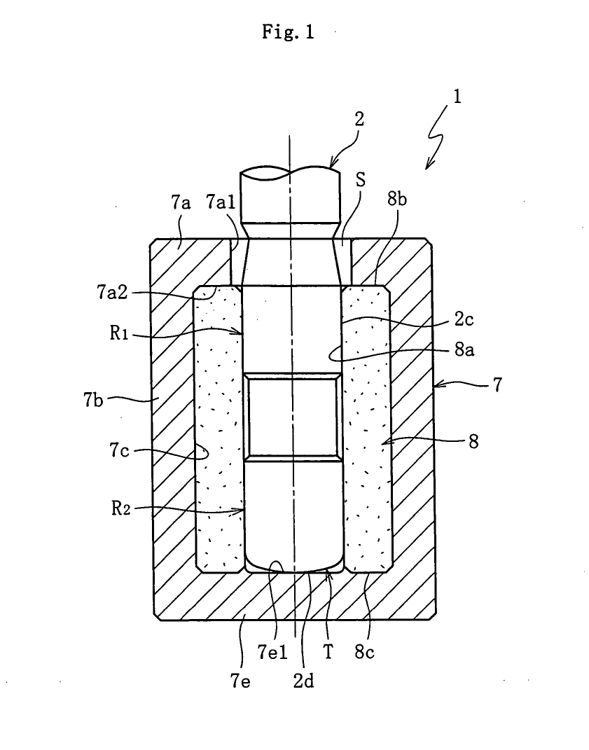

Preferred embodiments of the present invention will be hereinafter described, based on FIG. 1 to FIG. 3.

FIG. 3 shows one possible construction for a spindle motor for information-processing equipment, incorporating a fluid bearing device 1 according to this embodiment. This spindle motor is used in a disk drive device for HDD or the like, and comprises a fluid bearing device 1 which supports a shaft member 2 in a freely rotatable, non-contact manner, a disk hub 3 which is mounted onto the shaft member 2 using press fitting or the like, and a motor stator 4 and a motor rotor 5 which oppose one another across a gap in the radial direction. The stator 4 is attached to the outer periphery of a casing 6, and the rotor 5 is attached to the inner periphery of the disk hub 3. A housing 7 for the fluid bearing device 1 is mounted to the inner periphery of the casing 6. Either one disk or a plurality of disks D such as magnetic disks are supported by the disk hub 3. When current passes through the stator 4, the rotor 5 begins to rotate as a result of the excitation generated between the stator 4 and the rotor 5, thereby causing the disk hub 3 and the shaft member 2 to also rotate in a unified manner.

FIG. 1 is an enlarged sectional view of the fluid bearing device 1 described above. As shown in the figure, this fluid bearing device 1 comprises the housing 7, a circular cylindrical bearing sleeve 8, and the shaft member 2 as the primary structural components. In the following description, the open end of the housing (the sealed end) is described as the top, and the closed end of the housing 7 is described as the bottom.

The shaft member 2 is made of a conductive metal material such as stainless steel. The axial end portion (the bottom end in the figure) of the shaft member 2 is formed with a spherical surface, and by supporting this axial end portion 2d on the bottom portion 7e of the housing 7 in a contact manner, a pivot type thrust bearing portion T that supports the shaft member 2 in the thrust direction is formed. As described below, the contact portion of the thrust bearing portion T also functions as conducting means for ensuring conduction between the shaft member 2 and the housing 7. As well as the case shown in the figure, where the axial end portion 2d of the shaft member 2 directly contacts the inside surface 7e1 of the housing bottom portion 7e, a thrust plate made of a suitable low friction material (such as a resin) could also be positioned on the housing bottom portion 7e, and the axial end portion 2d then brought into sliding contact with this thrust plate.

The bearing sleeve 8 is secured to the inner peripheral surface of the housing 7, or more specifically to a predetermined position on the inner peripheral surface 7c of the side portion 7b, using a technique such as press fitting. There are no particular restrictions on the method of securing the bearing sleeve 8 to the inner periphery of the housing, provided conduction is possible between the two components, and a securing method that relies on partial adhesion between the two components is also possible.

The bearing sleeve 8 is formed in a circular cylindrical shape, from a porous body made of a sintered metal. Examples of the sintered metal include materials produced by using either one or more metal powders selected from the group consisting of copper, iron, and aluminum, or a coated metal powder or alloy powder such as copper coated iron powder as the primary raw material, adding powdered tin, zinc, lead, graphite, molybdenum disulfide or an alloy powder thereof as necessary, and then conducting molding and sintering operations. These sintered metals contain a plurality of internal pores (pores that function as part of the internal structure), and a plurality of surface openings formed when these pores connect through to the exterior surface. These sintered metals can be used as oil impregnated sintered metals by impregnating the sintered metal with a lubricating oil or a lubricating grease. In addition to sintered metals, the bearing sleeve 8 can also be formed using other metal materials such as soft metals, although at the very least, the sleeve is preferably formed using a conductive metal material.

A first radial bearing portion R1 and a second radial bearing portion R2 are provided between an inner peripheral surface 8a of the bearing sleeve 8 and an outer peripheral surface 2c of the shaft member 2, with the two bearing portions separated along the axial direction. The radial bearing surfaces, namely the first radial bearing portion R1 and the second radial bearing portion R2, are provided as upper and lower regions on the inner peripheral surface 8a of the bearing sleeve 8, with the two regions separated along the axial direction, and as dynamic-pressure generating means, herringbone shaped dynamic-pressure generating grooves are formed within these two regions. The dynamic-pressure generating means could also be formed from spiral shaped grooves or grooves running in the axial direction, or by forming the radial bearing surfaces with a non-circular shape (for example, as a plurality of arcs). Furthermore, the radial bearing surface regions can also be formed on the outer peripheral surface 2c of the shaft member 2.

The housing 7 is formed by injection molding (insert molding) of a resin material such as 66 nylon, LCP, or PES, with the bearing sleeve 8 described above as an insert component. A housing 7 formed in this manner is a cylindrical shape with a closed bottom, so that one end is open and the other is closed, and comprises a cylindrical side portion 7b, a ring-shaped seal portion 7a, which forms a single integrated unit with the side portion 7b and extends radially inward from the upper end of the side portion 7b, and a bottom portion 7e which is a continuation from the bottom end of the side portion 7b. An inner peripheral surface 7a1 of the seal portion 7a opposes the outer peripheral surface 2c of the shaft member 2 across a predetermined sealing space S. In this embodiment, the outer peripheral surface 2c of the shaft member 2, which opposes the inner peripheral surface 7a1 of the seal portion 7a to form the sealing space S, is formed as a taper which gradually narrows towards the top (towards the exterior of the housing 7). When the shaft member 2 and the bearing sleeve 8 undergo relative rotation (when the shaft member 2 is rotated in the case of this embodiment), the outer peripheral surface 2a of this tapered shape functions as a so-called centrifugal seal. In addition to this type of tapered space, the sealing space S can also be formed as a circular cylinder with the same diameter along the axial direction.

If the coefficient of linear expansion for this resin housing 7 is large, then there is a danger that the heat generated during operation of the bearing may cause the housing 7 to heat up and expand, causing deformation of the bearing sleeve 8, and thereby reducing the precision of the dynamic-pressure generating grooves formed in the inner peripheral surface 8a. In order to prevent this situation from occurring, the housing 7 is preferably made of a resin composition with a coefficient of linear expansion in the radial direction of 5×10⁻⁵/°C. or less.

The shaft member 2 is inserted inside the inner peripheral surface 8a of the bearing sleeve 8 until the axial end portion 2d contacts the inside surface 7e1 of the housing bottom portion 7e. The internal space within the housing 7, which is sealed by the seal portion 7a, is filled with a lubricating oil, and the radial bearing gaps of the radial bearing portions R1 and R2 are filled with the lubricating oil.

When the shaft member 2 is rotated, the regions (upper and lower regions) that function as the radial bearing surfaces for the inner peripheral surface 8a of the bearing sleeve 8 each oppose the outer peripheral surface of the shaft member 2 across a radial bearing gap. When the shaft member 2 rotates, a lubricating oil film is formed within this radial bearing gap, and the dynamic pressure of this oil film supports the shaft member 2 in a freely rotatable, non-contact manner in the radial direction. Accordingly, the first radial bearing portion R1 and the second radial bearing portion R2 are formed, which support the shaft member 2 in a non-contact manner in the radial direction, in a manner that enables free rotation. On the other hand, the shaft member 2 is supported in a freely rotatable manner in the thrust direction by the pivot shaped thrust bearing portion T.

In the present invention the housing 7 is made of a resin as described above, and this resin housing 7 is imparted with conductivity by mixing a conducting agent into the molten resin material. The level of that conductivity can be evaluated by the volume resistivity of the housing 7, and in the present invention, sufficient conducting agent is added to produce a volume resistivity of 10⁶ Ω·cm or less. In this description the volume resistivity refers to the resistance when a current flows through an object of dimensions 1 cm×1 cm×1 cm, and is defined as the resistance between opposing surfaces in a cube with a side of unit length.

In those cases in which the axial end portion 2d of the shaft member 2 is brought in contact with a thrust plate, the thrust plate is also made of either a resin that contains a conducting agent, or a conductive metal.

The conducting agent can use either a powdered material or a fiber-like material. If the particle size of the conducting agent is overly large, or the quantity added is too great, then the molten fluidity of the resin during injection molding of the housing 7 deteriorates, the dimensional precision of the molded product worsens, and when the housing 7 is press fitted inside the casing 6, there is a danger that the resulting sliding friction will cause the conducting agent to separate from the resin matrix, generating contamination. The results of investigations by the inventors of the present invention suggest that by combining either 8% by weight or less (and preferably 5% by weight or less) of a finely powdered conducting agent with an average particle size of 1 μm or smaller, or 20% by weight or less (and preferably 15% by weight or less) of a fibrous conducting agent with an average fiber diameter of 10 μm or smaller and an average fiber length of 500 μm or less, the problems described above can be avoided.

Examples of conducting agents that satisfy the above conditions are the carbon nanomaterials,. and particularly carbon nanofiber. By mixing 1 to 10% by weight, and preferably from 2 to 7% by weight, of this conducting agent into the resin matrix, a high level of conductivity (a volume resistivity of 10⁶ Ω·cm or less) can be imparted to the housing 7 with a minimal quantity of the conducting agent.

Examples of suitable carbon nanofibers include single-wall carbon nanotubes (SWCNT), multi-wall carbon nanotubes (MWCNT), cup-stacked type carbon nanofiber, and vapor grown carbon fiber (VGCF). SWCNT have an outer diameter of 0.4 to 5 nm and a length between 1 and several dozen μm, MWCNT have an outer diameter of 10 to 50 nm (and an internal diameter of 3 to 10 nm) and a length between 1 and several dozen μm, and cup-stacked type carbon nanofibers have an external diameter between 0.1 and several hundred μm and a max length of 30 cm.

During rotation of the shaft member 2, friction with the surrounding air causes a buildup of static electricity on the magnetic disk D. As described above, in the present invention the housing 7 is imparted with conductive properties, and consequently this static electricity passes through the disk hub 3, the shaft member 2, the contact portion between the axial end portion 2d and the housing bottom portion 7e, and the housing 7, before reaching the casing 6 and being discharged to ground. As a result, charging of the magnetic disk D can be reliably prevented, meaning both the development of a potential difference between the magnetic disk D and the magnetic head, and damage to equipment caused by the discharge of accumulated static electricity can be prevented.

If a conductive lubricating oil is also used as conducting means in addition to the thrust bearing portion T described above, then conduction between the shaft member 2 and the housing 7 can occur not only at the contact portion between the axial end portion 2d and the housing bottom portion 7e, but also via the lubricating oil, or a combination of the lubricating oil and the bearing sleeve 8, and consequently the static electricity prevention effect can be further enhanced.

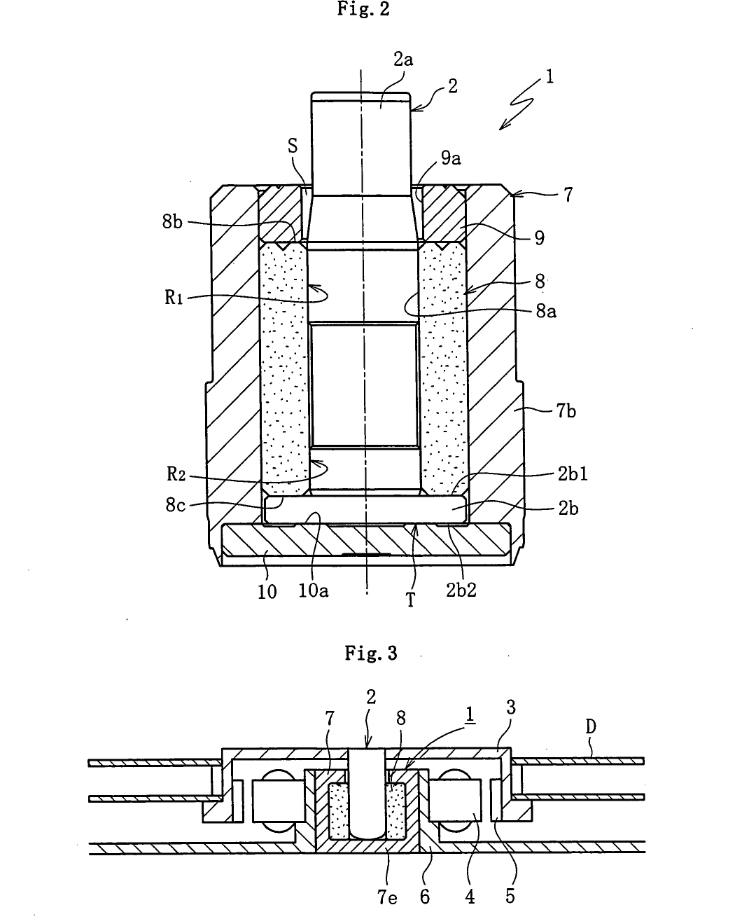

In addition to production by insert molding, the housing 7 can also be formed by injection molding (with no insert component) of the above resin material. FIG. 2 shows one such example, wherein at least the side portion 7b of the housing 7 is formed in a circular cylindrical shape by injection molding of a resin, and in this case the bottom portion 10 of the housing 7 is formed as a separate member made of either a resin or another material (such as a metal). By securing the bottom portion 10 within the opening at one end of the side portion 7b, using a technique such as press fitting, adhesive bonding or welding, a housing 7 comprising a circular cylindrical shape with a closed bottom is formed. The bearing sleeve 8 is secured to the inner peripheral surface of the side portion 7b using a technique such as press fitting. In addition, by securing a seal member 9 to the opening at the other end of the side portion 7b, a sealing space S is formed between the inner peripheral surface 9a of the seal member 10 and the outer peripheral surface of the shaft member 2.

Even with this construction, by adding a conducting agent as described above to the resin material used for forming the housing 7, conductivity can be imparted to the housing 7, enabling a powerful charging prevention effect.

In the embodiment shown in FIG. 1, a pivot bearing which supports the end portion of the shaft member 2 in a contact manner was shown as an example of the thrust bearing portion T, but a dynamic bearing, which in a similar manner to the radial bearing portions R1 and R2 generates pressure via a lubricating oil dynamic pressure effect generated within a bearing gap (the thrust bearing gap) by dynamic-pressure generating means such as dynamic-pressure generating grooves or the like, and then uses this pressure to support the shaft member 2 in a non-contact manner in the thrust direction, can also be used.

FIG. 2 shows one example of a thrust bearing portion T comprising a dynamic bearing, wherein the shaft member 2 comprises a shaft section 2a and a flange section 2b, and thrust bearing gaps are formed between the end surface 8c of the bearing sleeve 8 and the upper end surface 2b1 of the flange section 2b, and between the inside surface 10a of the housing bottom portion 10 and the lower end surface 2b2 of the flange section 2b, respectively. Dynamic-pressure generating grooves that function as dynamic-pressure generating means can be formed in either the bearing sleeve end surface 8c or the flange section upper end surface 2b1, and in either the inside surface 10a of the housing bottom portion 10 or the flange section lower end surface 2b2.

In such cases, during rotation of the shaft member 2, the shaft member 2 adopts a non-contact state with respect to both the housing 7 and the bearing sleeve, but by using a conductive lubricating oil as conducting means, conductivity can still be achieved between the shaft member 2 and the housing 7. In other words, static electricity on the shaft member 2 flows through the lubricating oil that is used to fill the bearing gaps (not only the radial bearing gap, but also the thrust bearing gaps), passes through the bearing sleeve 8, and flows into the housing 7, or alternatively flows directly into the housing 7 via the lubricating oil. Accordingly, a similar charging prevention effect to that of the embodiment shown in FIG. 1 can be achieved.

The present invention can also be applied in a similar manner to fluid bearing devices in which either one, or both of the radial bearing portions R1 and R2 are so-called cylindrical bearings.

Furthermore, the above description outlined an example in which the bearing sleeve 8 was made of a metal material such as a sintered metal or a soft metal, but a similar effect can also be achieved even if the bearing sleeve is made of the type of conductive resin composition described above, with a volume resistivity of 10⁶ Ω·cm or less.

As follows is a description of embodiments of the present invention.

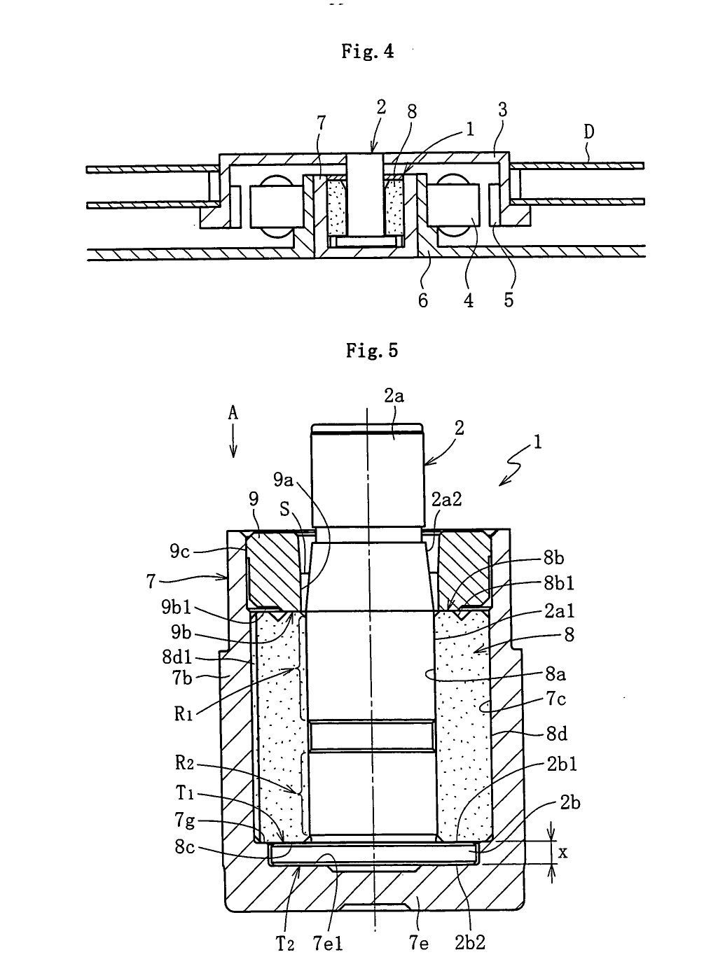

FIG. 4 is a schematic illustration showing one possible construction for a spindle motor for information-processing equipment, incorporating a dynamic bearing device (fluid dynamic bearing device) 1 according to this embodiment. This spindle motor is used in a disk drive device for HDD or the like, and comprises the dynamic bearing device 1, which supports a shaft member 2 in a freely rotatable, non-contact manner, a rotor (disk hub) 3 which is mounted onto the shaft member 2, and a stator 4 and a rotor magnet 5 which oppose one another across a gap in the radial direction, for example. The stator 4 is attached to the outer periphery of a bracket 6, and the rotor magnet 5 is attached to the inner periphery of the disk hub 3. A housing 7 for the dynamic bearing device 1 is mounted to the inner periphery of the bracket 6. Either one disk D or a plurality of disks D such as magnetic disks are supported by the disk hub 3. When current passes through the stator 4, the rotor magnet 5 begins to rotate as a result of the electromagnetic force generated between the stator 4 and the rotor magnet 5, thereby causing the disk hub 3 and the shaft member 2 to also rotate in a unified manner.

FIG. 5 shows the dynamic bearing device 1. This dynamic bearing device 1 comprises the housing 7, a bearing sleeve 8 and a seal member 9, both secured to this housing 7, and the shaft member 2 as the primary structural components.

A first radial bearing portion Ri and a second radial bearing portion R2 are provided between an inner peripheral surface 8a of the bearing sleeve 8 and an outer peripheral surface 2a1 of a shaft portion 2a of the shaft member 2, with the two bearing portions separated along the axial direction. Furthermore, a first thrust bearing portion T1 is provided between a lower end surface 8c of the bearing sleeve 8 and an upper end surface 2b1 of a flange portion 2b of the shaft member 2, and a second thrust bearing portion T2 is provided between an inner bottom surface 7e1 of a bottom portion 7e of the housing 7 and a lower end surface 2b2 of the flange section 2b. For the sake of ease of description, the bottom portion 7e side of the housing 7 is termed the lower side, and the opposite side to the bottom portion 7e is termed the upper side.

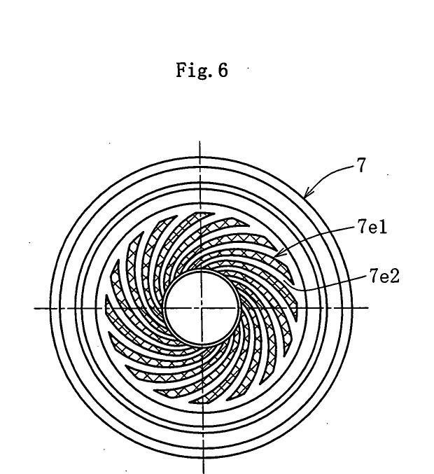

The housing 7 is formed in the shape of a cylinder with a closed bottom, for example, by injection molding of a resin material formed by combining 2 to 8% by weight of carbon nanotubes as a conductive filler material with a liquid crystal polymer (LCP) as the crystalline resin, and comprises a circular cylindrical side portion 7b, and a bottom portion 7e which is provided at the bottom end of the side portion 7b and forms a single integrated unit with the side portion 7b. As shown in FIG. 6, spiral shaped dynamic-pressure generating grooves 7e2 are formed in the inner bottom surface 7e1 of the bottom portion 7e which functions as the thrust bearing surface of the second thrust bearing portion T2. These dynamic-pressure generating grooves 7e2 are formed during the injection molding of the housing 7. In other words, by forming a groove pattern for generating the dynamic-pressure generating grooves 7e2 at the required location (the location where the inner bottom surface 7e1 is molded) in the molding die used to mold the housing 7, and transferring the shape of this groove pattern into the inner bottom surface 7e1 of the housing 7 during injection molding of the housing 7, it is possible to form the dynamic-pressure generating grooves 7e2 at the same time as the housing 7. Furthermore, a stepped portion 7g is formed as an integrated portion of the housing 7 at a location positioned a predetermined distance x in the axial direction above the inner bottom surface (the thrust bearing surface) 7e1.

The shaft member 2 is formed of a metal material such as stainless steel, and comprises the shaft portion 2a, and the flange portion 2b, which is provided at the bottom end of the shaft portion 2a, either as an integrated part of the shaft member or as a separate body.

The bearing sleeve 8 is formed, for example, in a circular cylindrical shape, from a porous body formed of a sintered metal, and particularly a sintered metal containing copper as a primary component, and is secured at a predetermined position on the inner peripheral surface 7c of the housing 7.

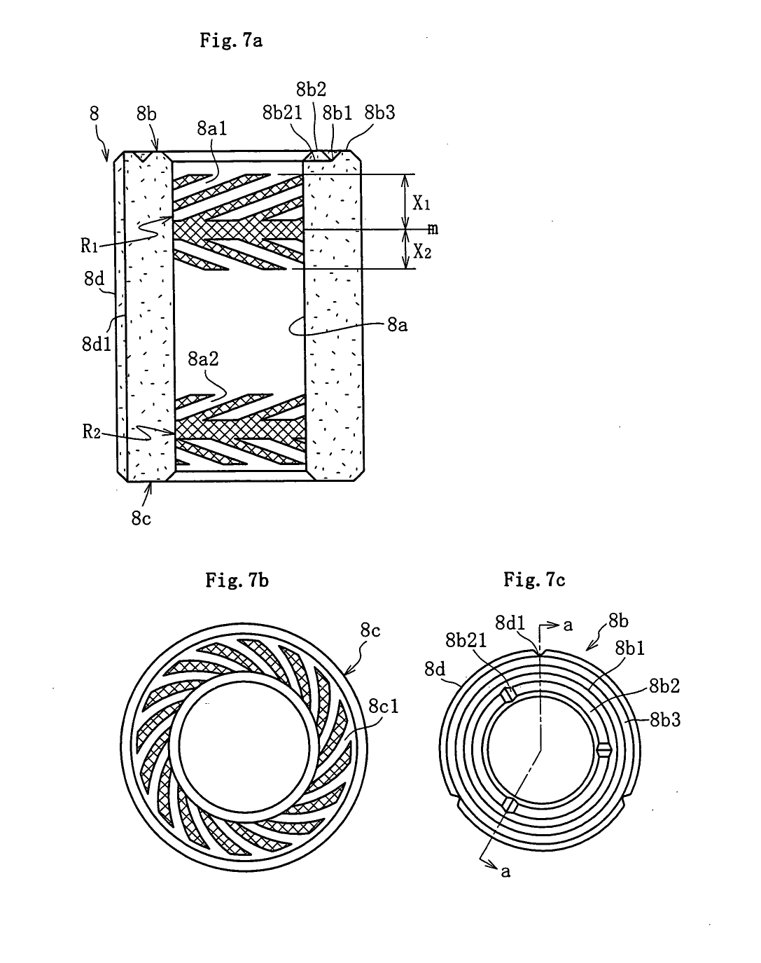

The radial bearing surfaces, namely the first radial bearing portion R1 and the second radial bearing portion R2, are provided as upper and lower regions on the inner peripheral surface 8a of the bearing sleeve 8 formed of sintered metal, with the two regions separated along the axial direction. Herringbone shaped dynamic-pressure generating grooves 8a1 and 8a2 are formed within these two regions, respectively, as shown in FIG. 7(a), for example. The upper dynamic-pressure generating grooves 8a1 are formed asymmetrically in the axial direction relative to the axial center m (the center in an axial direction between the upper and lower inclined grooves), so that from the axial center m, the axial dimension X1 to the top of the region is greater than the axial dimension X2 to the bottom of the region. Furthermore, either one, or a plurality of axial grooves 8d1 are formed in the outer peripheral surface 8d of the bearing sleeve 8, along the entire axial length of the sleeve. In this example, three axial grooves 8d1 are formed at equal intervals around the sleeve circumference.

Spiral shaped dynamic-pressure generating grooves 8c1 such as those shown in FIG. 7(b) are formed in the lower end surface 8c of the bearing sleeve 8, which forms the thrust bearing surface of the first thrust bearing portion T1.

As shown in FIG. 7(c), the upper end surface 8b of the bearing sleeve 8 is divided into an inner diameter region 8b2 and an outer diameter region 8b3 by a circumferential groove 8b1 provided at approximately the center of the end surface in the radial direction, and either one radial groove or a plurality of radial grooves 8b21 are formed in the inner diameter region 8b2. In this example, three radial grooves 8b21 are formed at equal intervals around the circumference.

The seal member 9 is secured to the inner periphery of the upper end portion of the side portion 7b of the housing 7, and has an inner peripheral surface 9a which opposes a tapered surface 2a2 provided at the outer periphery of the shaft portion 2a across a predetermined sealing space S. The tapered surface 2a2 of the shaft portion 2a gradually narrows towards the top (towards the exterior of the housing 7), and also functions as a centrifugal seal on rotation of the shaft member 2. Furthermore, an outer diameter region 9b1 of a lower end surface 9b of the seal member 9 is formed so as to have a slightly larger diameter than the inner diameter region.

The dynamic bearing device 1 according to this embodiment is assembled by the following process, for example.

First, the shaft member 2 is mounted to the bearing sleeve 8. The bearing sleeve 8 is inserted, together with the shaft member 2, inside the inner peripheral surface 7c of the side portion 7b of the housing 7 until the lower end surface 8c contacts the stepped portion 7g of the housing 7. This fixes the position of the bearing sleeve 8 relative to the housing 7, in the axial direction. In this state, the bearing sleeve 8 is secured to the housing 7 using a suitable technique such as ultrasonic welding.

Next, the seal member 9 is inserted inside the inner periphery of the upper end portion of the side portion 7b of the housing 7 until the inner diameter region of the lower end surface 9b contacts the inner diameter region 8b2 of the upper end surface 8b of the bearing sleeve 8. In this state, the seal member 9 is secured to the housing 7 using a suitable technique such as ultrasonic welding. Providing a convex rib 9c around the outer peripheral surface of the seal member 9 is an effective way to improve the tightness of the weld.

After the above assembly process is completed, the shaft portion 2a of the shaft member 2 is inserted inside the inner peripheral surface 8a of the bearing sleeve 8, so that the flange portion 2b is accommodated within the space between the lower end surface 8c of the bearing sleeve 8 and the inside bottom surface 7e1 of the housing 7. Subsequently, the internal space within the housing 7 sealed by the seal member 9, including the internal pores of the bearing sleeve 8, is filled with a lubricating oil. The surface of the lubricating oil is maintained within the sealing space S.

When the shaft member 2 rotates, the regions (namely, upper and lower regions) that function as the radial bearing surfaces on the inner peripheral surface 8a of the bearing sleeve 8 each oppose the outer peripheral surface 2a1 of the shaft portion 2a across a radial bearing gap. Furthermore, the region that forms the thrust bearing surface on the lower end surface 8c of the bearing sleeve 8 opposes the upper end surface 2b1 of the flange portion 2b across a thrust bearing gap, and the region that forms the thrust bearing surface on the inside bottom surface 7e1 of the housing 7 opposes the lower end surface 2b2 of the flange portion 2b across a thrust bearing gap. Then, as the shaft member 2 rotates, a lubricating oil dynamic pressure is generated within the above radial bearing gap, and the shaft portion 2a of the shaft member 2 is supported in a freely rotatable, non-contact state in the radial direction by the lubricating oil film that is formed within the radial bearing gap. Accordingly, the first radial bearing portion R1 and the second radial bearing portion R2 are formed, which support the shaft member 2 in a non-contact manner in the radial direction, in a manner that enables free rotation. At the same time, a lubricating oil dynamic pressure is also generated within the above thrust bearing gaps, and the flange portion 2b of the shaft member 2 is supported in a freely rotatable, non-contact state in both thrust directions by lubricating oil films that are formed within these thrust bearing gaps. Accordingly, the first thrust bearing portion T1 and the second thrust bearing portion T2 are formed, which support the shaft member 2 in a non-contact manner in the thrust direction, in a manner that enables free rotation. The thrust bearing gap (termed δ1) of the first thrust bearing portion T1 and the thrust bearing gap (termed δ2) of the second thrust bearing portion T2 can be managed with good precision using the equation x−w=δ1+δ2, based on the axial dimension x from the inside bottom surface 7e1 of the housing 7 to the stepped portion 7g, and the axial dimension (termed w) of the flange portion 2b of the shaft member 2.

As described above, the dynamic-pressure generating grooves 8a1 of the first radial bearing portion R1 are formed asymmetrically in the axial direction relative to the axial center m, so that from the axial center m, the axial dimension X1 to the top of the region is greater than the axial dimension X2 to the bottom of the region {see FIG. 7(a)}. As a result, during rotation of the shaft member 2, the retractive force (pumping force) of the lubricating oil generated by the dynamic-pressure generating grooves 8a1 is relatively greater in the upper region than the lower region. As a result of this retractive force pressure difference, the lubricating oil within the gap between the inner peripheral surface 8a of the bearing sleeve 8 and the outer peripheral surface 2a1 of the axial portion 2a flows downward, and follows a circulatory route through the thrust bearing gap of the first thrust bearing portion T1, the axial grooves 8d1, the ring shaped gap between the outer diameter region 9b1 of the lower end surface 9b of the seal member 9 and the outer diameter region 8b3 of the upper end surface 8b of the bearing sleeve 8, the circumferential groove 8b1 in the upper end surface 8b of the bearing sleeve 8, and then the radial grooves 8b21 in the upper end surface 8b of the bearing sleeve 8, before flowing once again into the radial bearing gap of the first radial bearing portion R1. By employing a, construction in which the lubricating oil circulates in this manner within the internal space within the housing 7, the phenomenon wherein the pressure of the lubricating oil in the internal space adopts a negative pressure in localized areas can be prevented, enabling the resolution of associated problems such as the generation of air bubbles accompanying the negative pressure generation, and the leakage of the lubricating oil or occurrence of vibration arising from such air bubble generation. Furthermore, even if air bubbles become entrapped within the lubricating oil for some reason, the air bubbles are circulated with the lubricating oil, and are expelled externally through the surface (gas-liquid interface) of the lubricating oil within the sealing space S, enabling the problems associated with air bubbles to be even more effectively prevented.

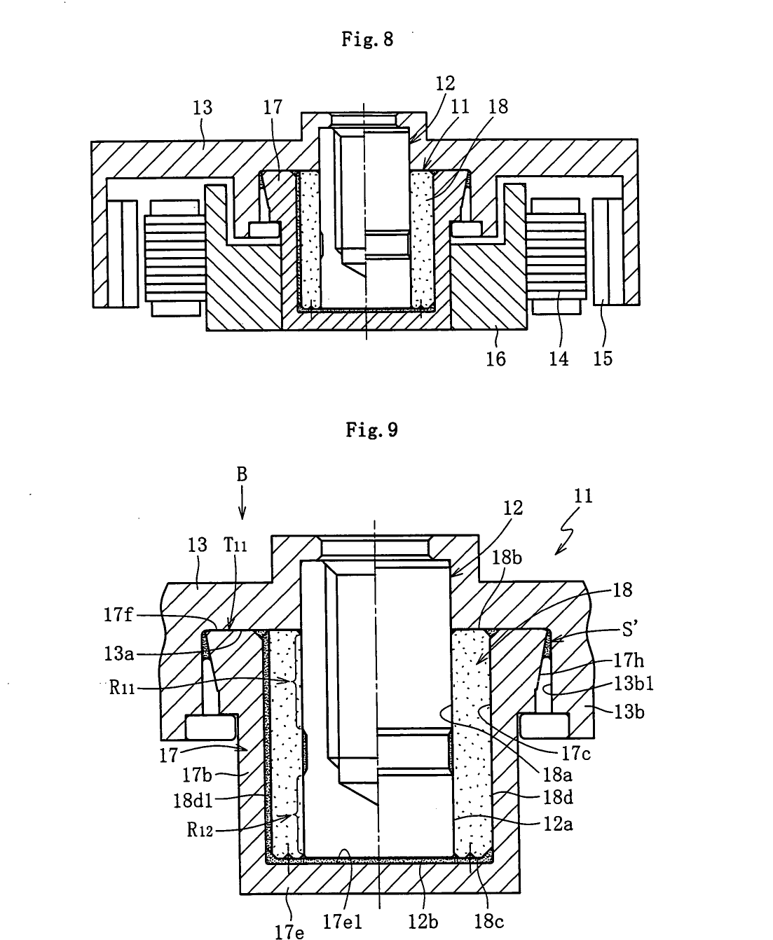

FIG. 8 is a schematic illustration showing one possible construction for a spindle motor for information-processing equipment, incorporating a dynamic bearing device (fluid dynamic bearing device) 11 according to another embodiment. This spindle motor is used in a disk drive device for HDD or the like, and comprises the dynamic bearing device 11, which supports a shaft member 12 in a freely rotatable, non-contact manner, a rotor (disk hub) 13 which is mounted to the shaft member 12, and a stator 14 and a rotor magnet 15 which oppose one another across a gap in the radial direction, for example. The stator 14 is mounted to the outer periphery of a bracket 16, and the rotor magnet 15 is mounted to the inner periphery of the disk hub 13. A housing 17 for the dynamic bearing device 11 is mounted to the inner periphery of the bracket 16. Either one disk or a plurality of disks such as magnetic disks are supported by the disk hub 13. When current passes through the stator 14, the rotor magnet 15 begins to rotate as a result of the electromagnetic force generated between the stator 14 and the rotor magnet 15, thereby causing the disk hub 13 and the shaft member 12 to also rotate in a unified manner.

FIG. 9 shows the dynamic bearing device 11. This dynamic bearing device 11 comprises the housing 17, a bearing sleeve 18 secured to the housing 17, and the shaft member 12 as the primary structural components.

A first radial bearing portion R11 and a second radial bearing portion R12 are provided between an inner peripheral surface 18a of the bearing sleeve 18 and an outer peripheral surface 12a of the shaft member 12, with the two bearing portions separated along the axial direction. Furthermore, a thrust bearing portion T11 is formed between an upper end surface 17f of the housing 17, and a lower end surface 13a of the disk hub (rotor) 13 secured to the shaft member 12. For the sake of ease of description, the bottom portion 17e side of the housing 17 is termed the lower side, and the opposite side to the bottom portion 17e is termed the upper side.

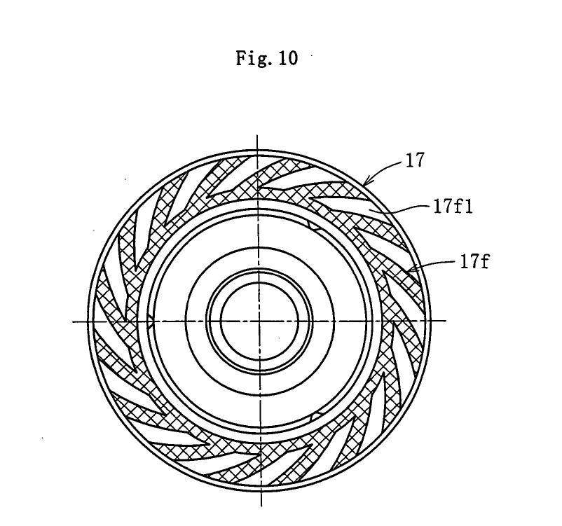

The housing 17 is formed in the shape of a cylinder with a closed bottom, for example, by injection molding of a resin material described above, and comprises a circular cylindrical side portion 17b, and a bottom portion 17e which is provided at the bottom end of the side portion 17b and forms a single integrated unit with the side portion 17b. As shown in FIG. 10, spiral shaped dynamic-pressure generating grooves 17f1, for example, are formed in the upper end surface 17f which functions as the thrust bearing surface of the thrust bearing portion T11. These dynamic-pressure generating grooves 17f1 are formed during the injection molding of the housing 17. In other words, by forming a groove pattern for generating the dynamic-pressure generating grooves 17f1 at the required location (the location where the upper end surface 17f is molded) in the molding die used to mold the housing 17, and transferring the shape of this groove pattern into the upper end surface 17f of the housing 17 during injection molding of the housing 17, it is possible to form the dynamic-pressure generating grooves 17f1 at the same time as the housing 17. Furthermore, at the upper part of the outer periphery of the housing 17, the housing 17 comprises a tapered outer wall 17h which gradually widens towards the top, and together with an inner wall 13b1 of a collar portion 13b provided on the disk hub 13, this tapered outer wall 17h, forms a tapered sealing space S′ which gradually narrows towards the top. During rotation of the shaft member 12 and the disk hub 13, this sealing space S′ connects through to the outer diameter side of the thrust bearing gap of the thrust bearing portion T11.

The shaft member 12 is formed of a metal material such as stainless steel, and the bearing sleeve 18 is formed, for example, in a circular cylindrical shape from a porous body formed of a sintered metal, and particularly a sintered metal containing copper as a primary component. The shaft member 12 is inserted inside the inner peripheral surface 18a of the bearing sleeve 18, and the bearing sleeve 18 is secured to a predetermined location on the inner peripheral surface 17c of the housing 17 by a suitable technique such as ultrasonic welding. When the shaft member 12 and disk hub 13 shown in FIG. 9 are stationary, there are slight gaps between the lower end surface 12b of the shaft member 12 and the inside bottom surface 17e1 of the housing 17, and between the lower end surface 18c of the bearing sleeve 18 and the inside bottom surface 17e1 of the housing 17.

Radial bearing surfaces, namely a first radial bearing portion R11 and a second radial bearing portion R12, are provided as upper and lower regions on the inner peripheral surface 18a of the bearing sleeve 18 formed of the sintered metal, with the two regions separated along the axial direction, and herringbone shaped dynamic pressure grooves, similar to those shown in FIG. 7(a) for example, are formed within these two regions. Furthermore, three axial grooves 18d1, for example, are formed along the entire axial length of the outer peripheral surface 18d of the bearing sleeve 18, at equal intervals around the sleeve circumference.

After the dynamic bearing device 11 is fully assembled, the internal space and the like of the housing 17 is filled with lubricating oil. In other words, the gap between the inner peripheral surface 18a of the bearing sleeve 18 and the outer peripheral surface 12a of the shaft member 12, the gap between the lower end surfaces 18c and 12b of the bearing sleeve 18 and the shaft member 12 respectively and the inside bottom surface 17e1 of the housing 17, the axial grooves 18d1 of the bearing sleeve 18, the gap between the upper end surface 18b of the bearing sleeve 18 and the lower end surface 13a of the disk hub 13, the thrust bearing portion T11, and the sealing space S′, are all filled with the lubricating oil, including the internal pores of the bearing sleeve 18.

When the shaft member 12 and the disk hub 13 rotate, the regions (namely, upper and lower regions) that function as the radial bearing surfaces on the inner peripheral surface 18a of the bearing sleeve 18 each oppose the outer peripheral surface 12a of the shaft member 12 across a radial bearing gap. Furthermore, the region that forms the thrust bearing surface on the upper end surface 17f of the housing 17 opposes the lower end surface 13a of the disk hub 13 across a thrust bearing gap. Then, as the shaft member 12 and the disk hub 13 rotate, a lubricating oil dynamic pressure is generated within the above radial bearing gap, and the shaft member 12 is supported in a freely rotatable, non-contact manner in the radial direction by the lubricating oil film that is formed within the radial bearing gap. Accordingly, the first radial bearing portion R11 and the second radial bearing portion R12 are formed, which support the shaft member 12 and the disk hub 13 in a non-contact manner in the radial direction, in a manner that enables free rotation. At the same time, a lubricating oil dynamic pressure is also generated within the above thrust bearing gap, and the disk hub 13 is supported in a freely rotatable, non-contact state in the thrust direction by the lubricating oil film that is formed within this thrust bearing gap. Accordingly, the thrust bearing portion T11 is formed, which supports the shaft member 12 and the disk hub 13 in a non-contact manner in the thrust direction, in a manner that enables free rotation.

Furthermore, the differential pressure between the retractive force (pumping force) of the lubricating oil generated by the dynamic-pressure generating grooves in the first radial bearing portion R11 and the retractive force of the lubricating oil generated by the dynamic-pressure generating grooves in the second radial bearing portion R12 causes the lubricating oil in the gap between the inner peripheral surface 18a of the bearing sleeve 18 and the outer peripheral surface 12a of the shaft member 12 to flow downward, and follow a circulatory route through the gap between the lower end surface 18c of the bearing sleeve 18 and the inside bottom surface 17e1 of the housing 17, the axial grooves 18d1, and then the gap between the lower end surface 13a of the disk hub 13 and the upper end surface 18b of the bearing sleeve 18, before flowing once again into the radial bearing gap of the first radial bearing portion R11. Accordingly, by employing a construction in which the lubricating oil circulates throughout the gaps described above, the phenomenon wherein the pressure of the lubricating oil in the internal space in the housing 17 and the thrust bearing gap of the thrust bearing portion T11 adopts a negative pressure in localized areas can be prevented, enabling the resolution of associated problems such as the generation of air bubbles accompanying the negative pressure generation, and the leakage of the lubricating oil or the occurrence of vibration arising from such air bubble generation. Furthermore, external leakage of the lubricating oil can be prevented even more effectively due to the capillary action of the sealing space S′, and the retractive force (pumping force) of the lubricating oil generated by the dynamic-pressure generating grooves 17f1 of the thrust bearing portion T11.

As follows is a description of embodiments of the present invention.

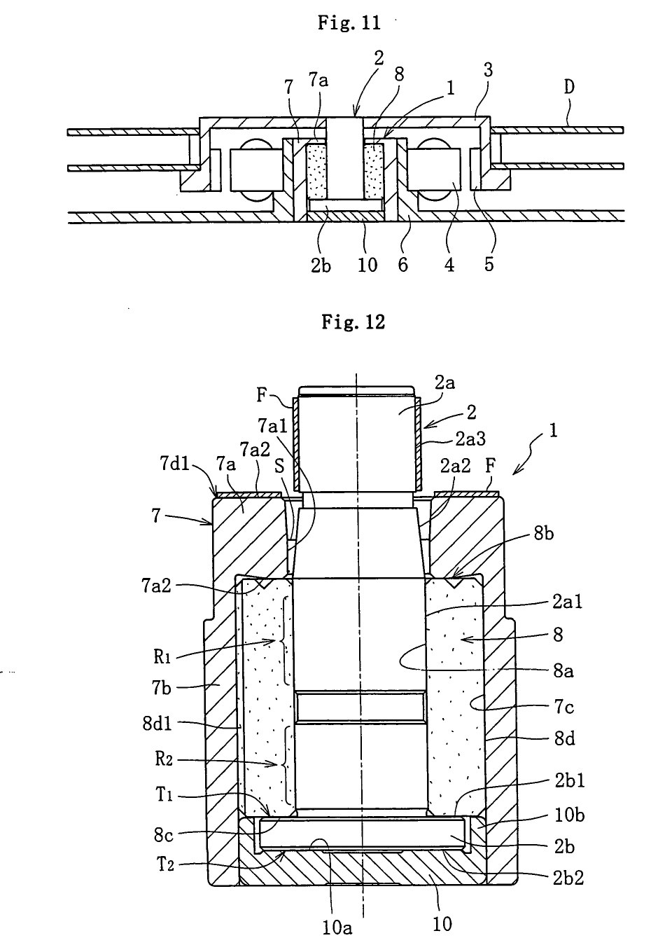

FIG. 11 is a schematic illustration showing one possible construction of a spindle motor for information-processing equipment incorporating a fluid bearing device (a fluid dynamic bearing device) 1 according to this embodiment. This spindle motor is used in a disk drive device for HDD or the like, and comprises a fluid bearing device 1 which supports a shaft member 2 in a freely rotatable, non-contact manner, a rotor (disk hub) 3 which is mounted onto the shaft member 2, and a stator 4 and a rotor magnet 5 which oppose one another across a gap in the radial direction, for example. The stator 4 is attached to the outer periphery of a bracket 6, and the rotor magnet 5 is attached to the inner periphery of the disk hub 3. A housing 7 for the fluid bearing device 1 is mounted to the inner periphery of the bracket 6. Either one disk or a plurality of disks D such as magnetic disks are supported by the disk hub 3. When current passes through the stator 4, the rotor magnet 5 begins to rotate as a result of the electromagnetic force between the stator 4 and the rotor magnet 5, thereby causing the disk hub 3 and the shaft member 2 to also rotate in a unified manner.

FIG. 12 shows the fluid bearing device 1. This fluid bearing device 1 comprises the housing 7, a bearing sleeve 8 and a thrust member 10 secured to this housing 7, and the shaft member 2 as the primary structural components.

A first radial bearing portion R1 and a second radial bearing portion R2 are provided between an inner peripheral surface 8a of the bearing sleeve 8 and an outer peripheral surface 2a1 of the shaft portion 2a of the shaft member 2, with the two bearing portions separated along the axial direction. Furthermore, a first thrust bearing portion T1 is provided between a lower end surface 8c of the bearing sleeve 8 and an upper end surface 2b1 of a flange portion 2b of the shaft member 2, and a second thrust bearing portion T2 is provided between an end surface 10a of the thrust member 10 and a lower end surface 2b2 of the flange portion 2b. For the sake of ease of description, the side where the thrust member 10 is positioned is termed the lower side and the side opposite to the thrust member 10 is termed the upper side.

The housing 7 is formed, for example, by injection molding of a resin material formed by combining 2 to 30 vol % of a conductive filler such as carbon nanotubes or conductive carbon with a crystalline resin such as a liquid crystal polymer (LCP), and comprises a circular cylindrical side portion 7b, and a ring shaped seal portion 7a which forms a single, continuous integrated unit with the side portion 7b and extends radially inward from the top end of the side portion 7b. An inner peripheral surface 7a1 of the seal portion 7a forms a predetermined sealing space S with an opposing outer peripheral surface 2a1 of the shaft portion 2a, such as a tapered surface 2a2 formed on the outer peripheral surface 2a1. The tapered surface 2a2 of the shaft portion 2a gradually narrows towards the top (towards the exterior of the housing 7), and functions as a centrifugal seal on rotation of the shaft member 2.

The shaft member 2 is formed of a metal material such as stainless steel, and comprises the shaft portion 2a, and the flange portion 2b, which is provided at the bottom end of the shaft portion 2a, either as an integrated part of the shaft member or as a separate body.

The bearing sleeve 8 is formed in a circular cylindrical shape, from a porous body formed of a sintered metal, and particularly a sintered metal containing copper as a primary component, and is secured at a predetermined position on the inner peripheral surface 7c of the housing 7.

The radial bearing surfaces, namely the first radial bearing portion R1 and the second radial bearing portion R2, are provided as an upper and lower region on the inner peripheral surface 8a of the bearing sleeve 8 formed of the sintered metal, with the two regions separated along the axial direction, and herringbone shaped dynamic-pressure generating grooves are formed within these two regions.

Either spiral shaped or herringbone shaped dynamic-pressure generating grooves are also formed in the lower end surface 8c of the bearing sleeve 8, which functions as the thrust bearing surface for the first thrust bearing portion T1.

The thrust member 10 is formed of a resin material or a metal material such as brass, and is secured to the lower end of the inner peripheral surface 7c of the housing 7. In this embodiment, the thrust member 10 also comprises an integrated, ring shaped contact portion 10b, which extends upwards from the outer peripheral edge of the end surface 10a. An upper end surface of this contact portion 10b contacts the lower end surface 8c of the bearing sleeve 8, and the inner peripheral surface of the contact portion 10b opposes the outer peripheral surface of the flange portion 2b across a gap. Herringbone shaped or spiral shaped dynamic-pressure generating grooves are also formed in the end surface 10a of the thrust member 10, which functions as the thrust bearing surface for the second thrust bearing portion T2. By controlling the axial dimensions of both the contact portion 10b of the thrust member 10 and the flange portion 2b, the thrust bearing gaps of the first thrust bearing portion T1 and the second thrust bearing portion T2 can be set with good precision.

The internal space within the housing 7 sealed by the seal portion 7a, including the internal pores within the bearing sleeve 8, is filled with a lubricating oil. The surface of the lubricating oil is maintained within the sealing space S. Furthermore, an oil repellent F is applied to the outside surface 7a2 adjacent to the inner peripheral surface 7a1 of the seal portion 7a. In addition, the oil repellent F is also applied to the outer peripheral surface 2a3 of the shaft member 2 that extends through the seal portion 7a and protrudes outside the housing 7.

When the shaft member 2 rotates, the regions (namely, upper and lower regions) that function as the radial bearing surfaces for the inner peripheral surface 8a of the bearing sleeve 8 each oppose the outer peripheral surface 2a1 of the shaft portion 2a across a radial bearing gap. Furthermore, the region that forms the thrust bearing surface on the lower end surface 8c of the bearing sleeve 8 opposes the upper end surface 2b1 of the flange portion 2b across a thrust bearing gap, and the region that forms the thrust bearing surface on the end surface lOa of the thrust member 10 opposes the lower end surface 2b2 of the flange portion 2b across a thrust bearing gap. Then, as the shaft member 2 rotates, a lubricating oil dynamic pressure is generated within the above radial bearing gap, and the shaft portion 2a of the shaft member 2 is supported in a freely rotatable, non-contact manner in the radial direction by the lubricating oil film that is formed within the radial bearing gap. Accordingly, the first radial bearing portion R1 and the second radial bearing portion R2 are formed, which support the shaft member 2 in a non-contact manner in the radial direction, in a manner that enables free rotation. At the same time, a lubricating oil dynamic pressure is also generated within the above thrust bearing gaps, and the flange portion 2b of the shaft member 2 is supported in a freely rotatable, non-contact manner in both thrust directions by lubricating oil films that are formed within these thrust bearing gaps. Accordingly, the first thrust bearing portion T1 and the second thrust bearing portion T2 are formed, which support the shaft member 2 in a non-contact manner in the thrust direction, in a manner that enables free rotation.

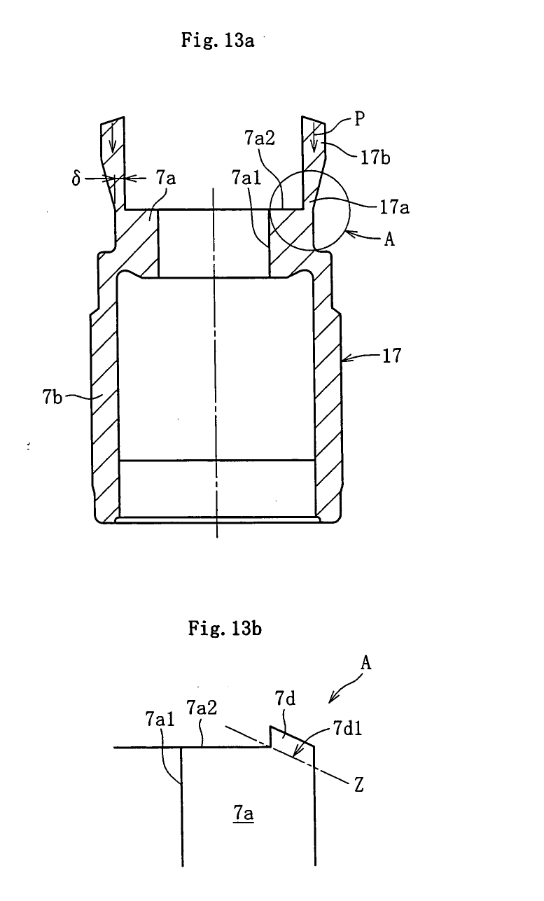

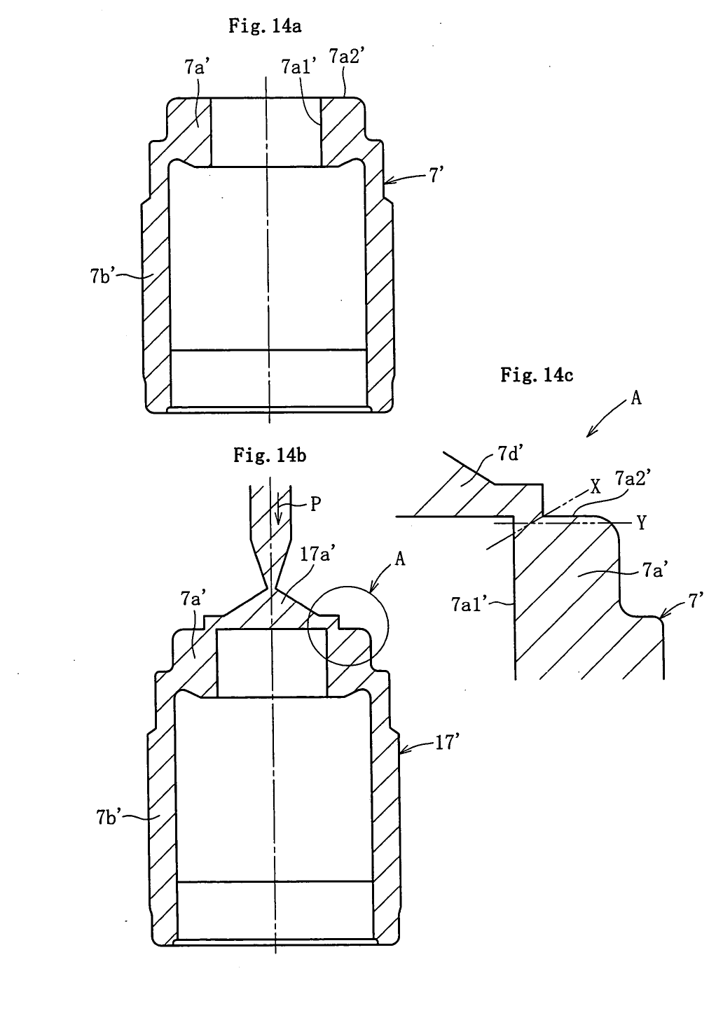

FIG. 13a shows a schematic illustration of a molding step for the housing 7 in a fluid bearing device 1 described above. A molding die comprising a stationary mold and a movable mold is provided with a runner 17b, a film gate 17a, and a cavity 17. The film gate 17a is formed in a ring shape in a position corresponding with the outer peripheral edge of the outside surface 7a2 of the seal portion 7a, and the gate width δ is set to 0.3 mm, for example.

Molten resin P ejected from the nozzle of an injection molding device, which is not shown in the figure, passes through the runner 17b and the film gate 17a of the molding die, and fills the inside of the cavity 17. By filling the cavity 17 with the molten resin P in this manner, through the ring shaped film gate 17a provided in a position corresponding with the outer peripheral edge of the outside surface 7a2 of the seal portion 7a, the molten resin P fills the cavity 17 uniformly in both a circumferential direction and an axial direction, enabling the production of a housing 7 with a high degree of dimensional precision.

Once the molten resin P that has filled the inside of the cavity 17 has cooled and hardened, the movable mold is moved and the molding die is opened. Because the film gate 17a is provided in a position corresponding with the outer peripheral edge of the outside surface 7a2 of the seal portion 7a, the molded product prior to opening of the die is shaped such that a film-like (thin) resin gate portion is connected in a ring shaped manner to the outer peripheral edge of the outside surface 7a2 of the seal portion 7a, but this resin gate portion fragments automatically during the operation of opening the molding die, so that when the molded product is removed from the molding die, a fragmented section of the resin gate portion 7d remains at the outer peripheral edge of the outside surface 7a2 of the seal portion 7a, as shown in FIG. 13(b). The housing 7 is completed by subsequently removing (by mechanical processing) this residual resin gate portion 7d along a line Z shown in the figure.

In the completed housing 7, a gate removal portion 7d1 formed by removing the resin gate portion 7d appears as a narrow ring shape at the outer peripheral edge of the outside surface 7a2 of the seal portion 7a. Accordingly, with the exception of the outer peripheral edge where the gate removal portion 7d1 is located, the outside surface 7a2 of the seal portion 7a is a molded surface as is, and by applying an oil repellent F to the outside surface 7a2 with this type of surface state, a satisfactory oil repellency effect can be achieved, enabling effective prevention of any leakage of the lubricating oil from inside the housing 7.

The present invention can be applied to both fluid bearing devices employing a so-called pivot bearing as the thrust bearing portion, and fluid bearing devices employing so-called cylindrical bearings as the radial bearing portion.

1. A fluid bearing device comprising:
a housing;
a bearing sleeve disposed inside the housing;
a shaft member inserted along an inner peripheral surface of the bearing sleeve; and
a radial bearing portion which supports the shaft member in a non-contact manner in a radial direction via a lubricating oil film that is generated within a radial bearing gap between the inner peripheral surface of the bearing sleeve and an outer peripheral surface of the shaft member, wherein
the fluid bearing device further comprises conducting means which enables conduction between the shaft member and the housing, and the housing is made of a conductive resin.

2. The fluid bearing device according to claim 1, wherein
the housing is made of a conductive resin composition with a volume resistivity of 10⁶ Ω·cm or lower.

3. The fluid bearing device according to claim 1, wherein
the housing is made of a conductive resin composition containing 8% by weight or less of a finely powdered conducting agent with an average particle size of 1 μm or smaller.

4. The fluid bearing device according to claim 1, wherein
the housing is made of a conductive resin composition containing 20% by weight or less of a fibrous conducting agent with an average fiber diameter of 10 μm or smaller and an average fiber length of 500 μm or less.

5. The fluid bearing device according to claim 1, wherein
the housing is made of a conductive resin composition containing a carbon nanomaterial as a conducting agent.

6. The fluid bearing device according to claim 5, wherein
the quantity of the carbon nanomaterial added thereto is set within a range from 1 to 10 wt %.

7. The fluid bearing device according to claim 5, wherein
the carbon nanomaterial is at least one type selected from the group consisting of single-wall carbon nanotubes, multi-wall carbon nanotubes, cup-stacked type carbon nanofiber, and vapor grown carbon fiber.

8. The fluid bearing device according to any one of claims 1 to 7, wherein
a coefficient of linear expansion of the housing in a radial direction is 5×10⁻⁵/°C. or lower.

9. The fluid bearing device according to claim 1, comprising a conductive lubricating oil used as the conducting means.

10. The fluid bearing device according to claim 1, comprising a thrust bearing portion which supports the shaft member in a contact manner in a thrust direction, used as the conducting means.

11. The fluid bearing device according to claim 1, wherein
the bearing sleeve is made of a metal or a conductive resin composition with a volume resistivity of 10⁶ Ω·cm or less.

12. A dynamic bearing device comprising:
a housing;
a bearing sleeve secured inside the housing;
a rotating member which undergoes relative rotation with respect to the housing and the bearing sleeve;
a radial bearing portion which supports the rotating member in a non-contact manner in a radial direction via a lubricating oil dynamic pressure effect that is generated within a radial bearing gap between the bearing sleeve and the rotating member; and
a thrust bearing portion which supports the rotating member in a non-contact manner in a thrust direction via a lubricating oil dynamic pressure effect that is generated within a thrust bearing gap between the housing and the rotating member, wherein
the housing is formed by molding a resin material, and comprises a thrust bearing surface which constitutes the thrust bearing portion and dynamic-pressure generating grooves which are formed in the thrust bearing surface during molding of the housing.

13. The dynamic bearing device according to claim 12, wherein
the thrust bearing surface is provided at an inner bottom surface at one end of the housing.

14. The dynamic bearing device according to claim 13, wherein
the housing has a stepped portion contacting an end surface at one end of the bearing sleeve.

15. The dynamic bearing device according to claim 14, wherein
the stepped portion is provided at a predetermined distance in an axial direction from the inner bottom surface of the housing.

16. The dynamic bearing device according to claim 12, wherein
the thrust bearing surface is provided at an end surface of the housing.

17. The dynamic bearing device according to any one of claims 12 to 16, wherein
the resin material used for forming the housing contains a conductive filler.

18. The dynamic bearing device according to claim 17, wherein
the conductive filler is one, or two or more selected from the group consisting of carbon fiber, carbon black, graphite, carbon nanomaterials, and metal powders.

19. A fluid bearing device comprising:
a housing;
a bearing sleeve disposed inside the housing;
a shaft member inserted along an inner peripheral surface of the bearing sleeve; and
a radial bearing portion which supports the shaft member in a non-contact manner in a radial direction via a lubricating oil film that is generated within a radial bearing gap between the inner peripheral surface of the bearing sleeve and an outer peripheral surface of the shaft member, wherein
the housing is formed by injection molding of a resin material, and comprises a cylindrical side portion and a seal portion which forms a single, continuous integrated unit with the side portion and extends radially inward from one end of the side portion,
the seal portion comprises an inner peripheral surface which forms a sealing space with an opposing outer peripheral surface of the shaft member, and an outside surface which is positioned adjacent to the inner peripheral surface, and
an outer peripheral edge of the outside surface comprises a gate removal portion formed by removing a resin gate portion.

20. The fluid bearing device according to claim 19, wherein
the gate removal portion is formed in a ring shape.

21. The fluid bearing device according to claim 19 or 20, wherein
he outside surface of the seal portion is applied with an oil repellent.

22. A method of manufacturing a fluid bearing device including a housing, a bearing sleeve disposed inside the housing, a shaft member inserted along an inner peripheral surface of the bearing sleeve, and a radial bearing portion which supports the shaft member in a non-contact manner in a radial direction via a lubricating oil film that is generated within a radial bearing gap between the inner peripheral surface of the bearing sleeve and an outer peripheral surface of the shaft member,
the method comprising a housing molding step of molding the housing by injection molding of a resin material, the housing having a shape comprising a cylindrical side portion, and a seal portion which forms a single, continuous integrated unit with the side portion and extends radially inward from one end of the side portion, wherein
the seal portion comprises an inner peripheral surface which forms a sealing space with an opposing outer peripheral surface of the shaft member, and an outside surface which is positioned adjacent to the inner peripheral surface, and
in the housing molding step, a ring shaped film gate is provided in a position corresponding with an outer peripheral edge of the outside surface of the seal portion, and a molten resin is injected through the film gate into a cavity used for molding the housing.

23. A motor for use in information-processing equipment, comprising the bearing device according to claim 1, 12, or 19.
